(19) United States
(12) Patent Application Publication
(10) Pub. No.: US 2017/0297539 A1
(43) Pub. Date: Oct. 19, 2017

(54) Undercarriage Washing Assembly

(71) Applicants: Graham Hills, Niagara Falls (CA); Sandra Hills, Niagara Fallls (CA)

(72) Inventors: Graham Hills, Niagara Falls (CA); Sandra Hills, Niagara Fallls (CA)

(21) Appl. No.: 15/130,553

(22) Filed: Apr. 15, 2016

(51) Int. Cl. B60S 3/04; B05B 7/30; B05B 1/14; B05B 7/00; B08B 3/02; B05B 12/00

(52) U.S. Cl. CPC B60S 3/04; B08B 3/026; B05B 12/002; B05B 1/14; B05B 7/0093; B05B 7/30

(57) ABSTRACT

An undercarriage washing assembly includes a base that may be rolled along a support surface. Thus, the base may be rolled beneath an undercarriage of a vehicle. A plurality of wheels is provided. Each of the wheels is rotatably coupled to the base to roll along the support surface. A handle is movably coupled to the base. A spray unit is coupled between the handle and the base. The spray unit may be coupled to a fluid source to deliver a fluid onto the undercarriage thereby facilitating the undercarriage to be cleaned. The spray unit includes a reservoir. The reservoir may contain a detergent thereby facilitating the spray unit to deliver the detergent to the undercarriage.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including Information Disclosed under 37 CFR 1.97 and 1.98

The disclosure and prior art relates to washing devices and more particularly pertains to a new washing device for cleaning an undercarriage of a vehicle.

### BRIEF SUMMARY OF THE INVENTION

An embodiment of the disclosure meets the needs presented above by generally comprising a base that may be rolled along a support surface. Thus, the base may be rolled beneath an undercarriage of a vehicle. A plurality of wheels is provided. Each of the wheels is rotatably coupled to the base to roll along the support surface. A handle is movably coupled to the base. A spray unit is coupled between the handle and the base. The spray unit may be coupled to a fluid source to deliver a fluid onto the undercarriage thereby facilitating the undercarriage to be cleaned. The spray unit includes a reservoir. The reservoir may contain a detergent thereby facilitating the spray unit to deliver the detergent to the undercarriage.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an undercarriage washing assembly according to an embodiment of the disclosure.

FIG. 2 is a right side view of an embodiment of the disclosure.

FIG. 3 is a top view of an embodiment of the disclosure.

FIG. 4 is a bottom view of an embodiment of the disclosure.

FIG. 5 is a cross sectional view taken along line 5-5 of FIG. 2 of an embodiment of the disclosure.

FIG. 6 is a perspective in-use view of an embodiment of the disclosure.

### DETAILED DESCRIPTION OF THE INVENTION

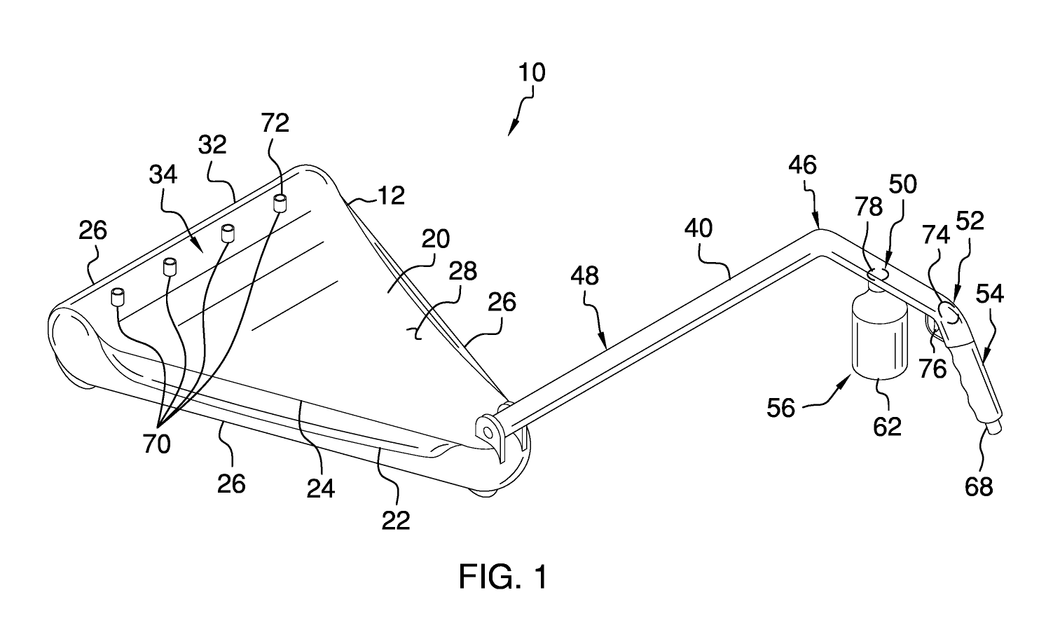

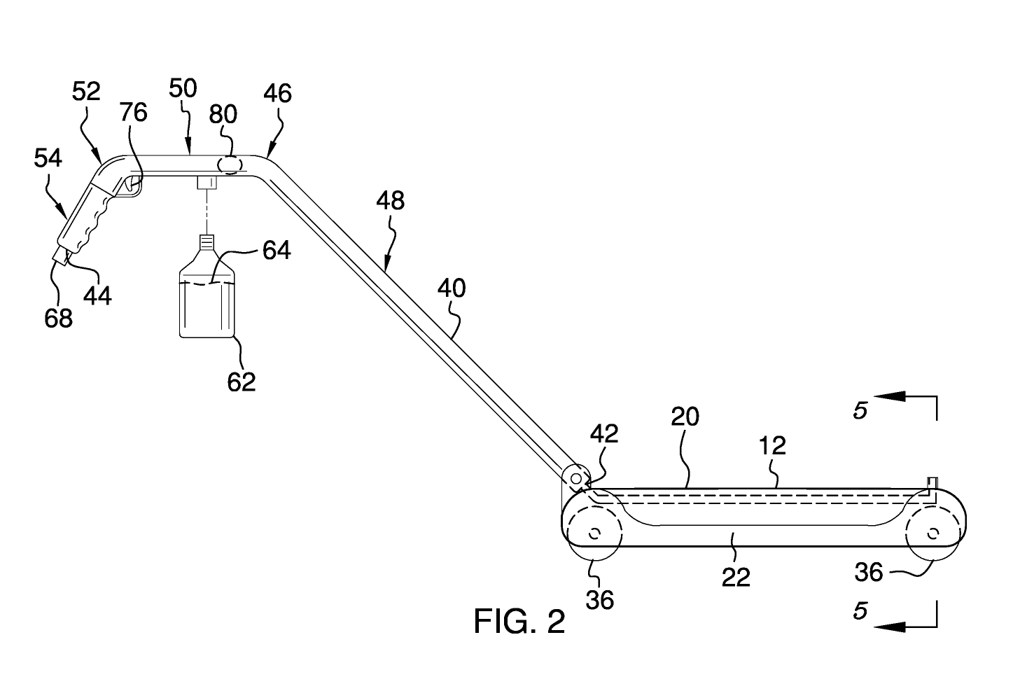

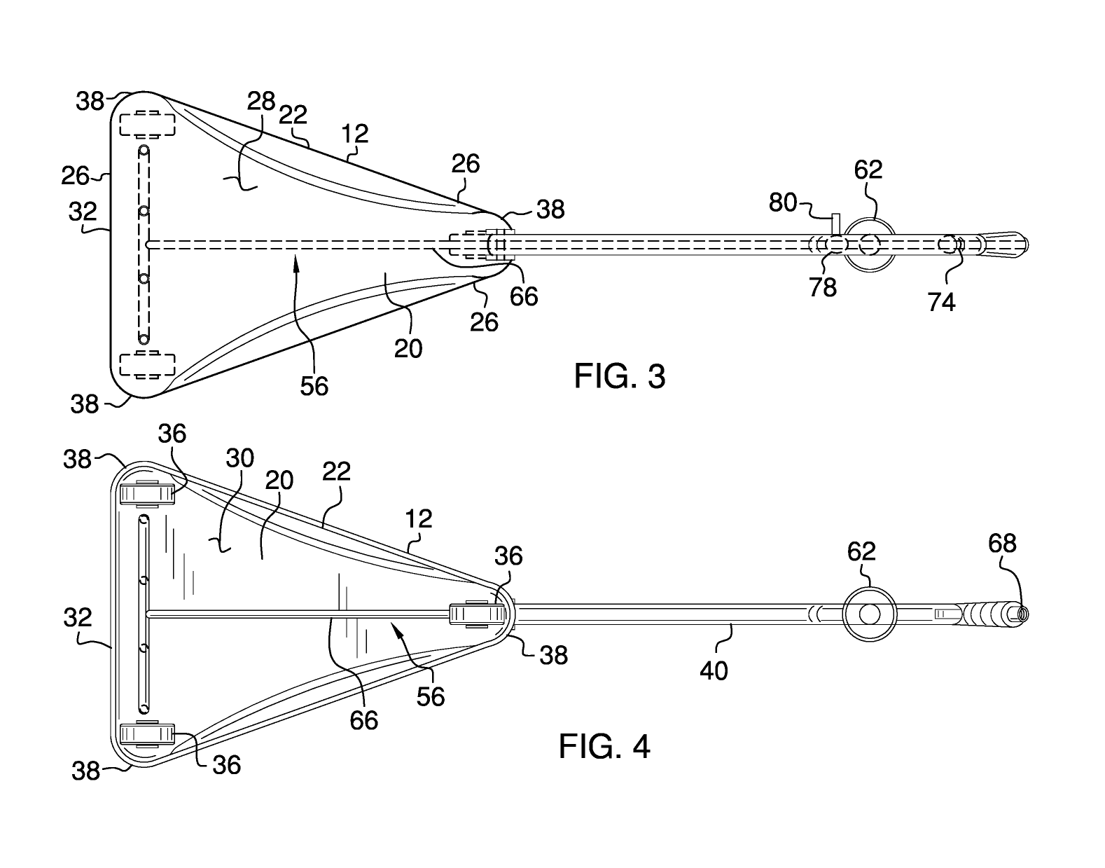

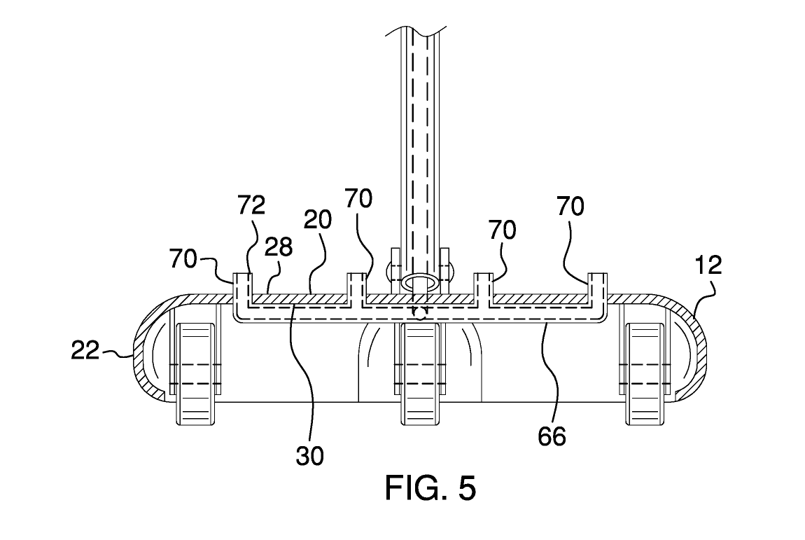

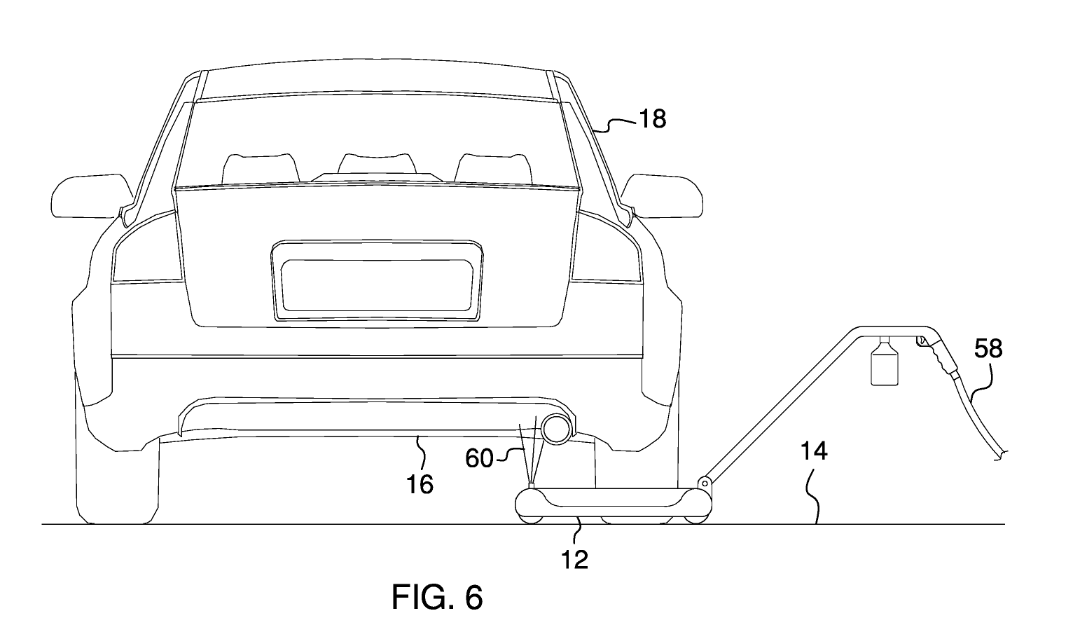

With reference now to the drawings, and in particular to FIGS. 1 through 6 thereof, a new washing device embodying the principles and concepts of an embodiment of the disclosure and generally designated by the reference numeral 10 will be described.

As best illustrated in FIGS. 1 through 6, the undercarriage washing assembly 10 generally comprises a base 12 that may be rolled along a support surface 14. The base 12 may be rolled beneath an undercarriage 16 of a vehicle 18. The vehicle 18 may comprise a passenger vehicle or the like. The support surface 14 may comprise ground.

The base 12 has a top wall 20 and a peripheral wall 22 extending downwardly from the top wall 20. The top wall 20 has an outer edge 24. The outer edge 24 has a plurality of intersecting sides 26 such that the top wall 20 has a triangular shape. The peripheral wall 22 is coextensive with the outer edge 24 of the top wall 20. The top wall 20 has a top surface 28 and a bottom surface 30. The intersecting sides 26 include a front side 32.

A plurality of wheels 36 is provided. Each of the wheels 36 is rotatably coupled to the base 12. Thus, each of the wheels 36 may roll along the support surface 14. Each of the wheels 36 is positioned on the bottom surface 30. Moreover, each of the wheels 36 is aligned with an associated one of three corners 38 of the base 12. Each of the wheels 36 is rotatable about an axis extending through the top surface 28 and the bottom surface 30 of the top wall 20.

A handle 40 is movably coupled to the base 12 and the handle 40 may be manipulated. The handle 40 has a first end 42 and a second end 44. The first end 42 is hingedly coupled to the top wall 20. The handle 40 has a first bend 46 thereon to define a first portion 48 forming an angle with respect to a second portion 50. The handle 40 has a second bend 52 thereon to define a third portion 54 forming an angle with respect to the second portion 50. The second bend 52 is spaced from the first bend 46. Each of the first portion 48 and the third portion 54 angle downwardly from the second portion 50.

A spray unit 56 is coupled between the handle 40 and the base 12. The spray unit 56 may be coupled to a fluid source 58. Thus, the spray unit 56 may deliver a fluid 60 onto the undercarriage 16. Thus, the undercarriage 16 may be cleaned. The spray unit 56 may remove salt, dirt and other corrosives that have collected on the undercarriage 16. Thus, the spray unit 56 may enhance a service life of the undercarriage 16.

The spray unit 56 facilitates the undercarriage 16 to be cleaned without keeling down or bending over. Additionally, the undercarriage 16 may be cleaned without lifting the vehicle 14 from the support surface 14. The fluid source 58 may comprise a garden hose or the like. The fluid 60 may comprise water.

The spray unit 56 includes a reservoir 62. The reservoir 62 may contain a detergent 64. Thus, the spray unit 56 may deliver the detergent 64 to the undercarriage 16. The detergent 64 may comprise a liquid soap or the like.

The spray unit 56 comprises a conduit 66 extending between the first end 42 of the handle 40 and the base 12. The conduit 66 extends along the bottom surface 30 of the base 12. A hose coupling 68 is coupled to the first end 42 of the handle 40. The hose 40 coupling is fluidly coupled to the conduit 66. The hose coupling 68 may be fluidly coupled to the fluid source 58 thereby facilitating the fluid 60 to be delivered to the conduit 66.

A plurality of nozzles 70 is provided and each of the nozzles 70 extends through the bottom surface 30 and the top surface 28 of the base 12. Each of the nozzles 70 is fluidly coupled to the conduit 66. Thus, the conduit 66 may deliver the fluid 60 to each of the nozzles 70. Each of the nozzles 70 has a distal end 72 with respect to the top surface 28. The distal end 72 corresponding to each of the nozzles 70 is open.

The distal end 72 corresponding to each of the nozzles 70 may spray the fluid 60 upwardly from the base 12. Thus, the fluid 60 may wash the undercarriage 16 when the base 12 is positioned beneath the vehicle 18. The nozzles 70 are spaced apart from each other and are distributed along the front side 32 of the base 12. Each of the nozzles 70 may comprise pressure washer nozzles or the like. Thus, each of the nozzles 70 may deliver the fluid 60 in a pressurized stream thereby enhancing cleaning the undercarriage 16.

The reservoir 62 is removably coupled to the handle 40. The reservoir 62 is in fluid communication with the conduit 66 when the reservoir 62 is coupled to the handle 40. Thus, the reservoir 62 may deliver the detergent 64 to the conduit 66. The reservoir 62 may be positioned on the second portion 50 of the handle 40. Additionally, the reservoir 62 may comprise a bottle or the like.

A first valve 74 is coupled to the handle 40. The first valve 74 is in fluid communication with the conduit 66 to selectively inhibit the fluid 60 from travelling to the nozzles 70. The first valve 74 includes a trigger 76 that is movably coupled to the handle 40. Thus, the trigger 76 may be manipulated. The fluid 60 to may travel to the nozzles 70 when the trigger 76 is manipulated. The trigger 76 may be positioned on the second portion 50 and the first valve 74 may comprise a fluid valve or the like.

A second valve 78 is coupled to the handle 40. The second valve 78 is in fluid communication with the reservoir 62. Thus, the second valve 78 may selectively inhibit the detergent 64 from being delivered to the conduit 66. The second valve 78 includes a knob 80 that is movably coupled to the handle 40. Thus, the knob 78 may be manipulated thereby facilitating the second valve 78 to deliver a selected amount of the detergent 46 to the nozzles 70.

The knob 78 may be positioned in a closed position thereby inhibiting the detergent 46 from being delivered to the nozzles 70. The knob 78 may be positioned between a minimum position and a maximum position. Thus, the second valve 78 may deliver an amount of the detergent 64 ranging between a minimum amount and a maximum amount. The second valve 78 may comprise a fluid valve or the like.

In use, the fluid source 58 is fluidly coupled to the hose coupling 68. The handle 40 is gripped and the base 12 is urged to be positioned beneath the vehicle 18. The trigger 76 is manipulated to spray the fluid 60 outwardly from the nozzles 70. Thus, the fluid 60 cleans the undercarriage 16. The knob 78 may be manipulated to deliver a selected amount of the detergent 64 to the nozzles. Thus, the detergent 64 enhances cleaning the undercarriage 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An undercarriage washing assembly being configured to wash an undercarriage of a vehicle, said assembly comprising:
a base being configured to be rolled along a support surface thereby facilitating said base to be rolled beneath an undercarriage of a vehicle;
a plurality of wheels, each of said wheels being rotatably coupled to said base wherein each of said wheels is configured to roll along the support surface;
a handle being movably coupled to said base wherein said handle is configured to be manipulated; and
a spray unit being coupled between said handle and said base, spray unit being configured to be coupled to a fluid source wherein said spray unit is configured to deliver a fluid onto the undercarriage thereby facilitating the undercarriage to be cleaned, said spray unit including a reservoir, said reservoir being configured to contain a detergent thereby facilitating said spray unit to deliver the detergent to the undercarriage.

2. The assembly according to claim 1, wherein said base has a top wall and a peripheral wall extending downwardly from said top wall, said top wall having an outer edge, said outer edge having a plurality of intersecting sides such that said top wall has a triangular shape, said peripheral wall being coextensive with said outer edge, said top wall having a top surface and a bottom surface, said intersecting sides including a front side.

3. The assembly according to claim 2, wherein each of said wheels is positioned on said bottom surface, each of said wheels being aligned with an associated one of three corners of said base, each of said wheels being rotatable about an axis extending through said top surface and said bottom surface of said top wall.

4. The assembly according to claim 2, wherein said handle has a first end and a second end, said first end being hingedly coupled to said top wall, said handle having a first bend thereon to define a first portion forming an angle with respect to a second portion, said handle having a second bend thereon to define a third portion forming an angle with respect to said second portion, each of said first portion and said third portion angling downwardly from said second portion.

5. The assembly according to claim 1, wherein:
said handle has a first end;
said base has a bottom surface; and
said spray unit comprises a conduit extending between said first end of said handle and said base, said conduit extending along said bottom surface of said base.

6. The assembly according to claim 5, further comprising a hose coupling being coupled to said first end of said handle, said hose coupling being fluidly coupled to said conduit, said hose coupling being configured to be fluidly coupled to the fluid source thereby facilitating the fluid to be delivered to said conduit.

7. The assembly according to claim 6, further comprising:
said base having a top surface and a front side; and
a plurality of nozzles, each of said nozzles extending through said bottom surface and said top surface of said base, each of said nozzles being fluidly coupled to said conduit wherein said conduit is configured to deliver the fluid to each of said nozzles, each of said nozzles having a distal end with respect to said top surface, said distal end corresponding to each of said nozzles being open wherein said distal end corresponding to each of said nozzles is configured to spray the fluid upwardly from said base thereby facilitating the fluid to wash the undercarriage when said base is positioned beneath the vehicle, said nozzles being spaced apart from each other and being distributed along said front side of said base.

8. The assembly according to claim 5, wherein said reservoir is removably coupled to said handle, said reservoir being in fluid communication with said conduit when said reservoir is coupled to said handle wherein said reservoir is configured to deliver the detergent to said conduit.

9. The assembly according to claim 7, further comprising a first valve being coupled to said handle, said first valve being in fluid communication with said conduit wherein said first valve is configured to selectively inhibit the fluid from travelling to said nozzles.

10. The assembly according to claim 9, wherein said first valve includes a trigger being movably coupled to said handle wherein said trigger is configured to be manipulated thereby facilitating the fluid to travel to said nozzles when said trigger is manipulated.

11. The assembly according to claim 7, further comprising a second valve being coupled to said handle, said second valve being in fluid communication with said reservoir wherein said second valve is configured to selectively inhibit the detergent from being delivered to said conduit, said second valve including a knob being movably coupled to said handle wherein said knob is configured to be manipulated thereby facilitating said second valve to deliver a selected amount of the detergent to said nozzles.

12. An undercarriage washing assembly being configured to wash an undercarriage of a vehicle, said assembly comprising:
a base being configured to be rolled along a support surface thereby facilitating said base to be rolled beneath an undercarriage of a vehicle, said base having a top wall and a peripheral wall extending downwardly from said top wall, said top wall having an outer edge, said outer edge having a plurality of intersecting sides such that said top wall has a triangular shape, said peripheral wall being coextensive with said outer edge, said top wall having a top surface and a bottom surface, said intersecting sides including a front side;
a plurality of wheels, each of said wheels being rotatably coupled to said base wherein each of said wheels is configured to roll along the support surface, each of said wheels being positioned on said bottom surface, each of said wheels being aligned with an associated one of three corners of said base, each of said wheels being rotatable about an axis extending through said top surface and said bottom surface of said top wall;
a handle being movably coupled to said base wherein said handle is configured to be manipulated, said handle having a first end and a second end, said first end being hingedly coupled to said top wall, said handle having a first bend thereon to define a first portion forming an angle with respect to a second portion, said handle having a second bend thereon to define a third portion forming an angle with respect to said second portion, each of said first portion and said third portion angling downwardly from said second portion; and
a spray unit being coupled between said handle and said base, spray unit being configured to be coupled to a fluid source wherein said spray unit is configured to deliver a fluid onto the undercarriage thereby facilitating the undercarriage to be cleaned, said spray unit including a reservoir, said reservoir being configured to contain a detergent thereby facilitating said spray unit to deliver the detergent to the undercarriage, said spray unit comprising:
a conduit extending between said first end of said handle and said base, said conduit extending along said bottom surface of said base,
a hose coupling being coupled to said first end of said handle, said hose coupling being fluidly coupled to said conduit, said hose coupling being configured to be fluidly coupled to the fluid source thereby facilitating the fluid to be delivered to said conduit,
a plurality of nozzles, each of said nozzles extending through said bottom surface and said top surface of said base, each of said nozzles being fluidly coupled to said conduit wherein said conduit is configured to deliver the fluid to each of said nozzles, each of said nozzles having a distal end with respect to said top surface, said distal end corresponding to each of said nozzles being open wherein said distal end corresponding to each of said nozzles is configured to spray the fluid upwardly from said base thereby facilitating the fluid to wash the undercarriage when said base is positioned beneath the vehicle, said nozzles being spaced apart from each other and being distributed along said front side of said base,
said reservoir being removably coupled to said handle, said reservoir being in fluid communication with said conduit when said reservoir is coupled to said handle wherein said reservoir is configured to deliver the detergent to said conduit,
a first valve being coupled to said handle, said first valve being in fluid communication with said conduit wherein said first valve is configured to selectively inhibit the fluid from travelling to said nozzles, said first valve including a trigger being movably coupled to said handle wherein said trigger is configured to be manipulated thereby facilitating the fluid to travel to said nozzles when said trigger is manipulated, and
a second valve being coupled to said handle, said second valve being in fluid communication with said reservoir wherein said second valve is configured to selectively inhibit the detergent from being delivered to said conduit, said second valve including a knob being movably coupled to said handle wherein said knob is configured to be manipulated thereby facilitating said second valve to deliver a selected amount of the detergent to said nozzles.
